(19) United States
(12) Patent Application Publication
(10) Pub. No.: US 2005/0214511 A1
(43) Pub. Date: Sep. 29, 2005

(54) Coated dimensional fabric

(76) Inventors: Kirkland W. Vogt, Simpsonvile, SC (US); Jane E. Armstrong, Blackley (GB)

Correspondence Address: Legal Department;Milliken & Company (M-495), 920 Milliken Road, P.O. Box 1926, Spartanburg, SC, 29304, US

(21) Appl. No.: 11/063,186

(22) Filed: Feb. 22, 2005

Related U.S. Application Data
(60) Provisional application No. 60/547,243, filed on Feb. 24, 2004.

(51) Int. Cl. B32B 5/02; B32B 27/04; B32B 27/12

(52) U.S. Cl. 428/172; 428/195.1; 442/103; 442/148

(57) ABSTRACT

A family of composite fabrics is disclosed, such fabrics comprising a relatively thick, contoured textile substrate or base onto which is applied a coating to provide an upholstery fabric having a unique appearance and texture. Surface contours, and in some cases portions of the underlying base fabric over which the coating is applied and subsequently removed through processing-induced abrasion, tend to be visible through breaks in the opaque coating, thereby imparting to the composite a decorative, three-dimensional quality.

### CROSS-REFERENCE TO RELATED APPLICATION

This application claims priority to and benefit of U.S. Provisional Patent Application Ser. No. 60/547,243, filed on Feb. 23, 2004, which is hereby incorporated by reference herein.

### SUMMARY OF THE INVENTION

This disclosure relates to a family of composite fabrics comprising a relatively thick, contoured textile substrate or base onto which is applied a coating to provide an upholstery fabric having a unique appearance and texture. Surface contours, and in some cases portions of the underlying base fabric over which the coating is applied and subsequently removed through processing-induced abrasion, tend to be visible through breaks in the opaque coating, thereby imparting to the composite a decorative, three-dimensional quality. In one embodiment, the coated fabric undergoes a dyeing step in which coating material is selectively abraded from the protruding elements of the contoured fabric surface as part of the dyeing step. In another embodiment, the coating is abraded in a separate step, prior to the dyeing step. In either case, the resulting composite fabric has a contoured surface in which the coating largely obscures the underlying base fabric except in places where the coating material has been abraded away. If the coating and the dyeing step involve different colors, a multi-colored effect is obtained. In any case, the resulting composite fabric presents a unique combination of hand and appearance, and one that facilitates repeatable color matches.

Optionally, one or more additional fabrics or substrates may be attached to the base, on the surface opposite to the coated surface, thereby constructing a multi-layered sheet composite. Such optional additions may provide physical integrity, stability while cutting, padding, etc., to the composite fabric and perhaps better adapt the composite fabric to various upholstery applications, as, for example, in automotive and other transportation applications, interior furnishing applications for domestic or hospitality markets, etc.

Details of various embodiments and variations of such composite fabrics, and methods for making such fabrics, are explained below, with the aid of the accompanying drawings and definitions.

### BRIEF DESCRIPTION OF THE DRAWINGS

The content of FIGS. 1 through 3, as referenced in the description that follows, is summarized below.

FIG. 1 diagrammatically depicts an exemplary contoured base fabric (with an optional backing layer 40) prior to the application of a suitable coating composition. FIG. 1A depicts the fabric of FIG. 1 following the application of a suitable coating composition. FIG. 1B shows a detail of an edge portion of the coated base fabric of FIG. 1A.

FIGS. 2A through 2D depict, in cross-section, two other exemplary contoured and coated base fabrics; in FIG. 2A, the fabric was not treated with a chemical finish prior to coating, and the coating has not yet been abraded. FIG. 2B shows exemplary results of abrasively treating the fabric of FIG. 2A—the coating has been occasionally abraded away from around some of the “peak” areas of the contoured face of base fabric 20. FIG. 2C shows a base fabric 20 that was treated with a chemical finish 20 prior to coating. FIG. 2D shows exemplary results of abrasively treating the fabric of FIG. 2C; the coating 30 has been abraded away to a greater degree from around most of the “peak” areas of the contoured face of the base fabric 20.

FIGS. 3A and 3B are process flow diagrams depicting steps, including alternative and optional steps, by which the fabric exemplified in FIGS. 1, 1A, 2B, and 2D may be manufactured. In each of the FIGS. 3A and 3B, dotted lines indicate actions or steps that are individually optional.

### DETAILED DESCRIPTION OF THE INVENTION

As used herein, the following terms shall have the indicated meanings, unless express language or context otherwise dictates.

Contoured, locally contoured, or local contouring, as those terms are used herein, shall refer to undulations, depressions, or other sources of surface relief that cause the face or back of a fabric to be non-planar, i.e., to deviate from a smooth planar surface over a relatively localized area, for example, within an area or region of perhaps one or several square centimeters, so as to impart a three-dimensional pattern to the surface of the fabric. Typically, but not necessarily, the contour is replicated regularly throughout the fabric. However, for example, a logo desirably may be reproduced only in selected areas. The depth of contouring (i.e., the maximum difference in elevation or base fabric thickness between high and low contour features, respectively referred to as “peaks” and “valleys”) is intended to be greater than that normally associated with the slightly textured surface common to regular woven or knitted flat fabrics. In such flat woven and knit fabrics, the crossover points of the yarns create the largest “contours” of the fabric, with a depth of contouring measured (as if viewed in cross-section) from the top of the bottom yarn (in the “valley”) to the top of the crossover yarn (on the adjacent “peak”). For example, in a flat woven fabric, it is the elevation change in going from the top of a fill yarn to the top of a warp yarn on the adjacent fill yarn. In contrast, the fabrics discussed for use herein have surface contours that are created periodically, for example, by means of specific construction (use of larger and smaller yarns), using specific fabric formation methods capable of creating topographically patterned (i.e., non-planar) constructions, or with finishing techniques.

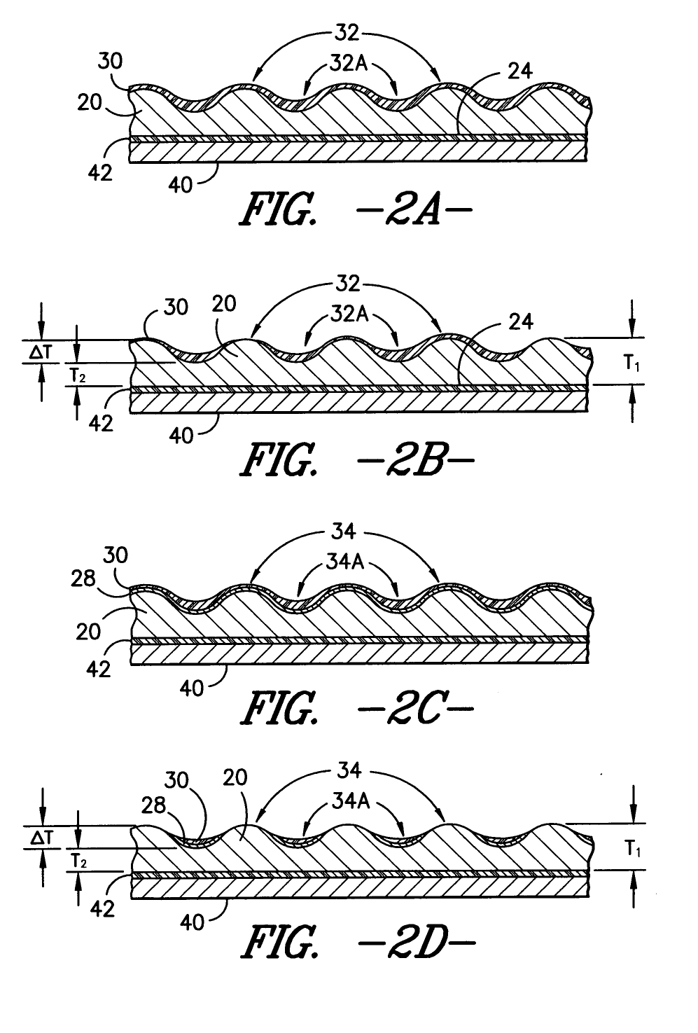

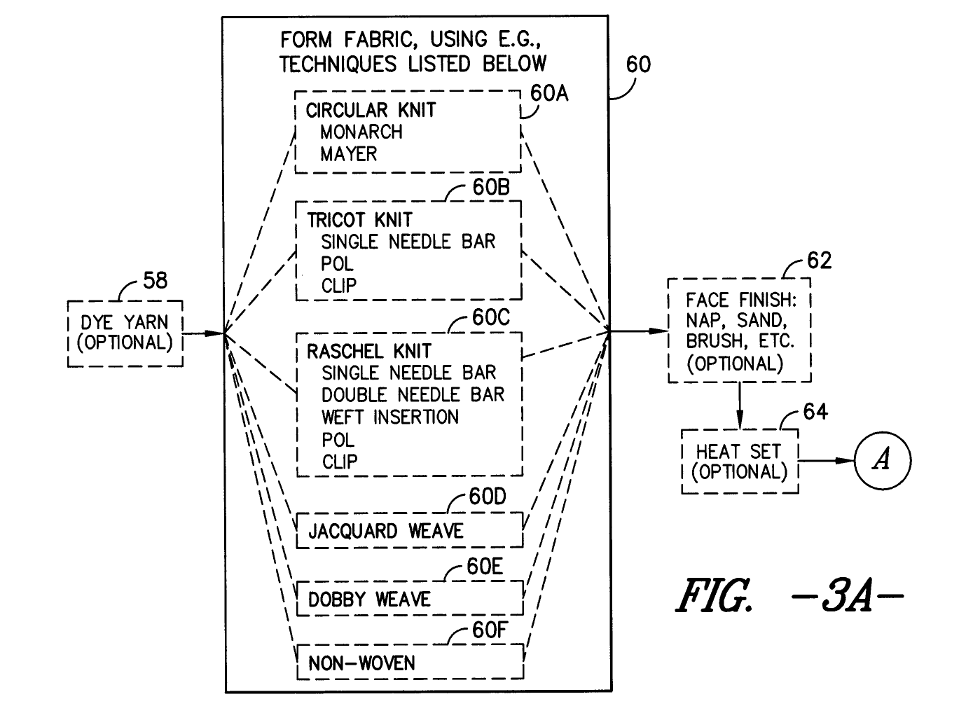

Thickness T, as used to describe a base fabric, shall refer to the uncompressed thickness of the base fabric (i.e. the distance separating the parallel planes that define, respectively, the uppermost surface of the face—the elevation of the highest peak—and the back of the fabric). As shown in FIGS. 2B and 2D, T₁ refers specifically to the maximum uncompressed thickness of the base and T₂ refers to the minimum uncompressed thickness of the base—measured at the bottom of the deepest valley—in situations where the base is locally contoured.

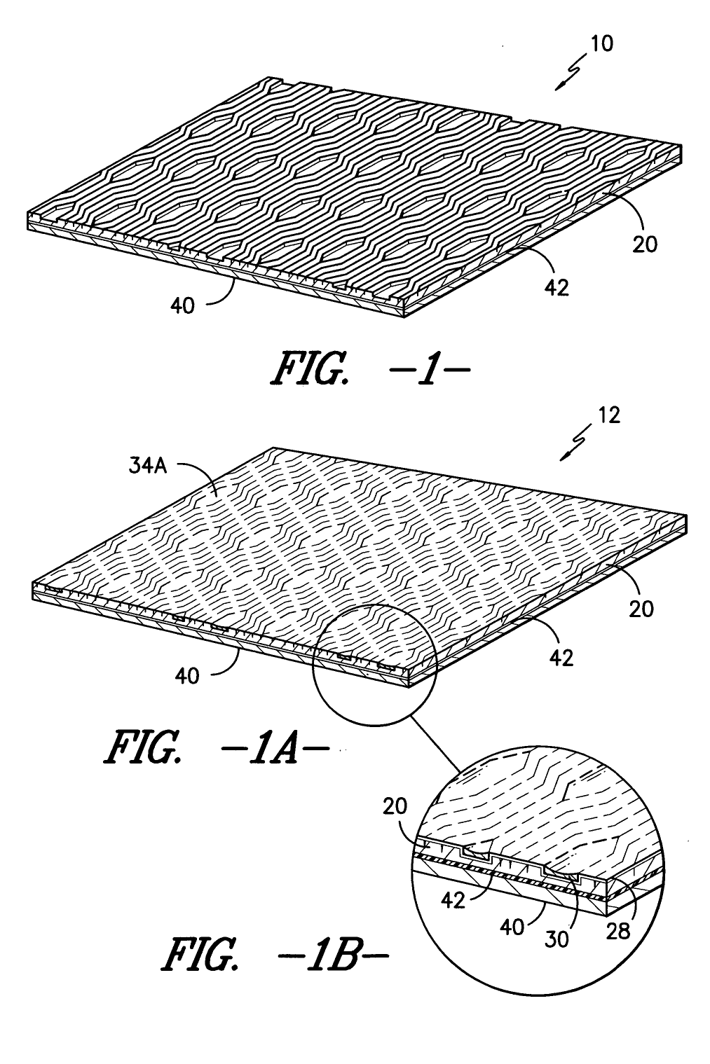

The composite shown in FIG. 1 is comprised of a relatively thick substrate or base 20, having a contoured face. Optionally, a backing member 40 comprised of, for example, a back coating, an attached scrim, an attached non-woven substrate, or a relatively thin layer of open- or closed-cell foam may be attached to the back of the base 20 in order to give the composite physical integrity, stability while cutting, or necessary weight, to establish a desired barrier for the rear surface of the composite, or to provide some other desirable attribute. Details of each of these components, along with (1) preferred embodiments, (2) process steps in manufacture, and (3) options and alternatives, are discussed below.

Base Fabric

Base fabric or substrate 20 may be constructed using any of a wide variety of textile materials, depending upon the desired characteristics of the composite and the selected technique used for constructing the base fabric. For example, fibers or yarns comprised of commonly available materials such as nylon, polyester, polypropylene, or cellulosic materials (e.g., rayon, cotton, etc.) may be used, as well as various engineered materials such as those marketed by Dupont (e.g., Nomex®, Kevlar®, etc.). Possible constructions of base fabric 20 include various types of weaving and knitting, as well as the use of non-woven constructions, as discussed below. Most commonly, base fabric 20 will have a non-pile surface; however, base fabric 20 may have a pile surface that is subsequently contoured or patterned (e.g., via optional Step 70, also discussed below).

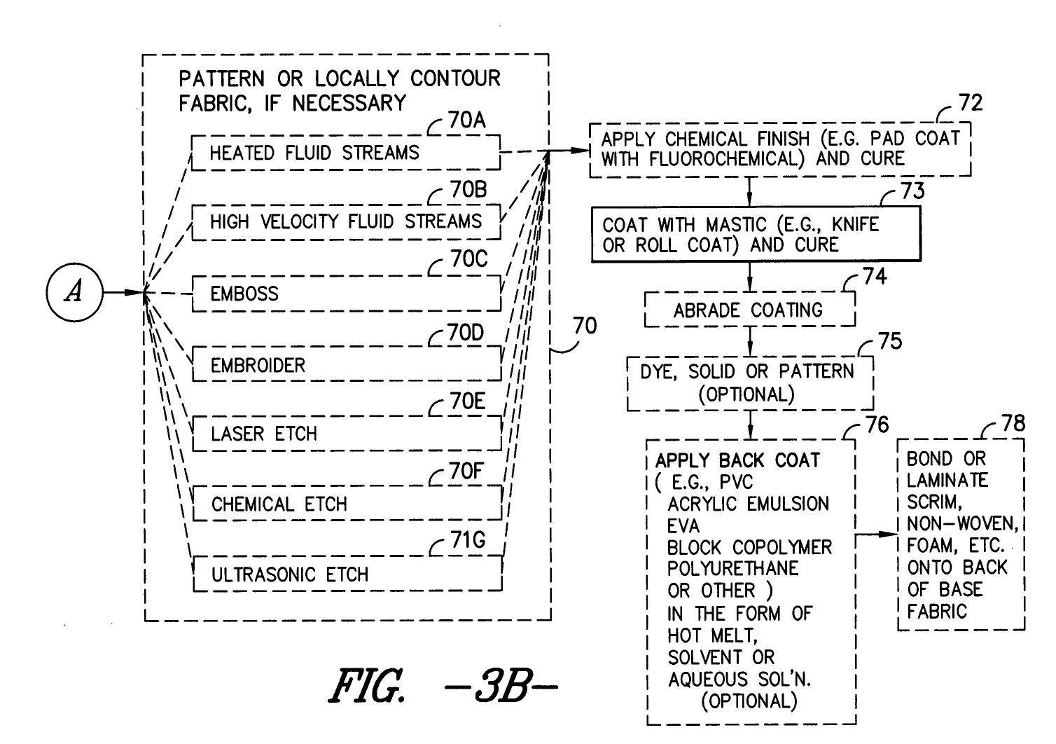

Looking at FIG. 3A, Blocks 58 through 64 outline several possible steps by which a suitable base fabric may be constructed. Beginning at optional Step 58, the selected yarn (or yarns, if different types are used) optionally may be dyed, as where accent yarns in the final product are required or where yarns particularly suited to solution dyeing (e.g., polypropylene) are used. However, in general, it should be emphasized that any such step would be supplementary to the dyeing step of Step 74 following coating, which step is considered a characteristic part of the process disclosed herein.

Step 60 represents the fabric formation step in which the base fabric is generated. As indicated in FIG. 3A, this step may involve various forms of knitting, weaving, or the generation of a non-woven substrate. The objective of this step is to form a fabric having a thickness that exceeds most single-component fabrics, and that provides for sufficiently deep contouring to provide the desired visual effect in the completed composite fabric. Generally, the bases contemplated herein will have a minimum uncompressed thickness (indicated at T₁ in FIGS. 2B and 2D) not less than about 0.3 mm to about 1.0 mm, with practical maximum thicknesses falling within the range of about 1.0 mm to about 10.0 mm. In many cases, bases in which T₁ falls within the range of about 0.5 mm to about 5.0 mm have been found to be preferable. Although not shown, any slitting or similar operations known by those skilled in the art to be necessary to provide the fabric in the desired form is implicit in Step 60.

Following fabric formation Step 60, the resulting fabric optionally may be subjected to various appropriate face finishing operations, such as napping, sanding, brushing, or the like, as signified in optional Step 62. The appropriately face-finished fabric then may be optionally subjected to a heat setting step, depicted at 64, to stabilize the base fabric's width, shrinkage characteristics, etc., as desired.

The local contouring of base fabric 20 can be imparted as part of the fabric formation process of Step 60 (e.g., jacquard weaving, dobby weaving, circular knitting, tricot knitting, or Raschel knitting, etc), or can be imparted or enhanced during a subsequent step (such as depicted at optional step 70 in FIG. 3B), in which a base fabric that may have been formed with insufficient contouring, or that was formed with a planar surface (e.g., no local contouring) is treated to establish such a locally contoured surface. Individual processes associated within Step 70, as listed in FIG. 3B, include localized yarn shrinkage or melting by heated fluid streams (e.g., Step 70A, as, for example, is disclosed in commonly assigned U.S. Pat. No. 5,148,583), yarn dislocation by high velocity fluid streams (e.g., Step 70B, as, for example, is disclosed in commonly assigned U.S. Pat. No. 5,235,733), yarn deformation, as by, for example, embossing (Step 70C), and yarn melting or degradation (e.g., Steps 70E through G). This collection of techniques is intended to be non-exclusive—it is contemplated that two or more may be used on the same base fabric, and that other conventional processes may readily be used or adapted for use in providing local contouring to base fabric 20 as may occur to those skilled in the art. Fabrics that emerge from Step 60 as locally contoured may also be subjected to one or more of the processes of Step 70 if additional or enhanced contouring is desired.

The depth of contouring (i.e., the difference in fabric thickness measured at various lateral locations across the face of fabric 20) is dependent upon a number of factors, including the initial depth of the base fabric 20 and the visual effect to be achieved with the resulting coated fabric. Typically, this difference in thickness or elevation (diagrammatically depicted in FIGS. 2B and 2D as ΔT) will be at least 0.2 mm, and more typically will lie within the range of about 0.5 mm to about 1.5 mm, but could easily be greater, e.g., as much as a centimeter or more, if the base fabric is sufficiently thick and extreme contouring is necessary or desired. For example, if the composite is to be used in applications where sound absorption is important, deep contouring adapted to increase surface area or to accommodate sounds of specific short wavelengths may be used.

Referring to FIGS. 2A and 2B, it is contemplated that T₁ have a value that is at least 0.3 mm or greater, and preferably 1.0 mm or greater, with T₂ ranging in value from perhaps 90% of the value of T₁ to perhaps 10% (or less) of T₁, so long as base 20 maintains sufficient physical integrity to allow for manufacture. It is also contemplated that T₂ could, in fact, be 0%, indicating the case where the base fabric is perforated with holes that extend the entire distance T₁ and that would likely be occluded by the coating.

Following such contouring step 70, a chemical finish or treatment optionally may be applied (optional Step 72) to the base fabric. In a preferred embodiment, such treatment is comprised of the application (e.g., by spraying, coating, or other conventional means appropriate to the characteristics of the base fabric and the finish) of a fluorochemical that will tend to reduce the degree to which any subsequently applied coating composition (see Step 73) adheres to the “peaks” or areas of maximum thickness of base fabric 20, to be discussed below.

Generally, repellent fluorochemicals useful in the present invention include any of the fluorochemical compounds and polymers known in the art to impart water- and oil-repellency to fibrous substrates. These repellent fluorochemical compounds and polymers typically comprise one or more fluorochemical radicals that contain a perfluorinated carbon chain having from 3 to about 20 carbon atoms, more preferably from about 6 to about 14 carbon atoms. These fluorochemical radicals can contain straight chain, branched chain, or cyclic fluorinated allcylene groups or any combination thereof. Commercially available examples of repellent fluorochemicals that may be used include, but are not limited to, the Scotchgard™ family of repellent fluorochemicals by 3M, the Zonyl™ family of repellent fluorochemicals by Dupont, the Repearl™ family of repellent fluorochemicals by Mitsubishi International Corporation, such as Repearl® F-8025 or Repearl® F-7000. Other fluorochemicals, such as the Unidyne™ products distributed by Daikin America, Inc. or products distributed by OMNOVA Solutions may also be employed. In addition to fluorochemicals, other repellent chemistry, such as repellent silicones, may also be employed.

Coating the Face of the Base Fabric

In Step 73, the undyed base fabric 20 is coated using any convenient technique (e.g., knife or roll coat) that will accommodate the characteristics of the base fabric and the selected coating composition. However, use of a knife coater has been found to be particularly effective, in that the coating tends to accumulate in the depressions of the contours and is at least partially scraped or otherwise removed from many or most of the countour “peaks” of the base fabric 20.

In one preferred embodiment, the coating composition is comprised of a 100% solids silicone coating, such as that distributed by Wacker Chemicals, of Adrian, Mich., as LR3003/10A and LR3003/10B, mixed according to directions. Other types of coatings are contemplated, such as mastics or other materials containing, for example, acrylics, polyurethanes, blocked copolymers, etc., that are individually or in combination capable of providing the necessary viscosity, adhesion, durability, and possibly other desirable characteristics. An example of one such coating is a blocked isocyanate polyurethane, marketed as Impranil® 80 and available from Bayer Chemicals, of Leverkusen, Germany. The selected coating composition may, but need not, contain pigment, depending upon the visual effect desired in the finished fabric. However, in any case, the viscosity of the coating composition, as applied, should be such that the composition flows into the contours of the base fabric, but remains primarily on the contoured surface of the base fabric, i.e., it does not penetrate to a great degree into the underlying structure of the base fabric. Generally, coatings having viscosities within the range of about 80,000 centipoise to about 400,000 centipoise using a Brookfield LV spindle number 4 at 1.5 rpm, and more particularly, between about 200,000 centipoise and about 300,000 centipoise, have been found to produce fabrics having the desirable characteristics described herein. It is contemplated that, depending upon the coating application technology used, the physical construction of the base fabric, the nature of any chemicals previously applied to the surface, and other factors, viscosities falling outside the above-defined ranges may still have the desirable flowable-yet-non-penetrating qualities discussed above. Following application, the coating of choice should be appropriately cured.

Optional Step 74 provides for use of a separate means to abrade the coated fabric prior to the dyeing step. Such means can comprise use of abrasively coated rolls or other materials, high velocity fluid jets, etching techniques (including laser techniques), sanding, brushing, sand or shot blasting techniques, or other conventional means known to those skilled in the art, including at least some of those described in connection with Step 70, above. It is also contemplated that washing the coated fabric in a way that causes the fabric to rub against itself or the confines of the washing vessel may produce a desirable degree of coating removal.

In optional Step 75 in FIG. 3B, the base fabric carrying the cured coating may be dyed (keeping in mind that, if the base fabric 20 was constructed using dyed yarns, indicated at Step 58, such dyeing is optional). If abrading Step 74 is used, and coating 30 is already eroded, any suitable dyeing technique may be used. If coating 30 is insufficiently eroded, then use of a jet dyeing technique (or other technique in which the base fabric is tumbled or otherwise manipulated to allow for selective abrasion of the coating) is preferably used. In either case, erosion of the coating 30 allows for preferential dyeing of the underlying fabric base in those areas where the coating has been selectively abraded. If the coating carries a pigment, such dyeing can be in a color that complements or contrasts with the color imparted to the coating.

Optional Step 76 provides for the application of a coating to the back of the base fabric. Such coating can be comprised of any of a variety of materials, such as PVA, acrylic emulsions, EVA, various block copolymers, polyurethane, and other common or conventional treatments used to back coat textiles, applied, for example, as a hot melt, or in an aqueous or solvent-based solution. Optional Step 78 provides for the bonding or lamination, again to the back of the base fabric, of an additional layer such as, for example, a scrim, an open or closed cell foam, or a non-woven web. It is contemplated that Steps 76 and 78 may be used individually or together in situations where one or more additional layers are desired on the back of the base fabric, perhaps to give the base fabric additional physical integrity, cutting stability, weight, or bulk, to provide a barrier to moisture or a contaminant, or to assist in subsequent parts molding operations, etc.

FIGS. 2A through 2D depict, in cross section, two alternative embodiments of the product resulting from the process described in FIGS. 3A and 3B. FIG. 2A depicts a coated base fabric 20 with no chemical finish having been applied prior to the application of coating 30. Depending upon the choice of coating material, the coating technique used, and other factors, the relative uniformity in coating thickness may vary, but the difference in coating thickness between the “peaks” 32 and the “valleys” 32A, as indicated, is relatively insignificant.

FIG. 2B depicts the fabric of 2A following an abrasive dyeing step (or following a separate abrading step and a separate dyeing step). The coating 30 is largely intact in the “valley” areas 32A, and is present, although in somewhat eroded form, on a significant number—perhaps a majority—of the “peaks,” indicated collectively at 32. The degree to which the coating 30 is eroded depends upon several factors, including the degree of abrasion experienced by the base fabric 20, the adhesion properties of the coating 30 in relation to the selected base fabric, and the nature of the contouring.

FIG. 2C depicts a fabric similar to that depicted in FIG. 2A, but on which a chemical finish 28 of the kind discussed above has been applied prior to the coating operation. As discussed above in the case of the fabric of FIG. 2A, the applied coating 30 is more-or-less uniform in thickness, with some accumulation in the valley portions 34A of the contoured base fabric 20. Such insignificant non-uniformity is in contrast to the situation depicted in FIG. 2D, in which the coated base fabric 20 of FIG. 2C has been subjected to an abrasive dyeing step (or a separate abrading step followed by a separate dyeing step), with substantial removal of coating 30 in evidence. In the portion of the fabric shown, the coating 30 (as well as the chemical finish 28) on each of the “peak” areas 34 has been removed, leaving the underlying base fabric 20 exposed. The degree and lateral extent to which the coating 30 and perhaps the chemical finish 28 is removed is a function of several variables, including (1) the nature of the coating and coating application techniques used, (2) the nature of the dyeing technique used to dye the coated base fabric (e.g., as when jet dyeing techniques are used, and, as part of the process, the coating is abraded from portions of the contoured surface of the base fabric), (3) the use of a separate processing step, discussed above and shown at 74 in FIG. 3B, in which the coating is selectively removed through sanding, washing, laser etching, use of abrasively-coated rolls (as described, for example, in commonly assigned U.S. Pat. No. 5,943,745, or the like, (4) the nature of the contour of the base fabric (e.g., sharp “peaks” vs. flat plateau areas), or (5) a combination of the foregoing. It is in areas in which the coating (and, most likely, the underlying chemical finish) has been substantially removed (rather than simply thinned), as shown at 34 in FIG. 2D, in which optional dyeing step 75, by imparting the selected dye color to such areas, can have a substantial effect upon the appearance of the overall coated fabric.

The specific embodiments and parameters presented throughout this description are exemplary and illustrative only, and are not intended to be limiting in any way. It is contemplated that other, substantially equivalent materials, configurations, arrangements, parameter values, and specific functions may be substituted without departing from the spirit of the teachings herein. Therefore, it is not intended that the scope of the development disclosed herein be limited to specific embodiments illustrated and described.

1. A composite fabric comprising a textile substrate comprised of yarns and having a face and a back, said face being locally contoured and having, within a localized area, relatively elevated areas and relatively depressed areas, wherein said face carries a cured coating of non-uniform thickness that is thicker in said relatively depressed areas than in said relatively elevated areas.

2. The fabric of claim 1 wherein said coating is absent from at least some of said relatively elevated areas.

3. The fabric of claim 1 wherein said local contouring of said face is the result of the arrangement of yarns associated with the specified textile construction of said substrate.

4. The fabric of claim 1 wherein at least some of said yarns comprising said substrate are dyed.

5. The fabric of claim 1 wherein at least a portion of said coating has been removed from at least some of said relatively elevated areas, thereby exposing the underlying yarns from such areas, while substantially maintaining said coating in at least some of said depressed areas.

6. The fabric of claim 1 wherein said at least some of said yarns comprising said substrate are dyed a first color, and said coating carries a colorant of a second color.

7. The fabric of claim 5 wherein said at least some of said yarns comprising said substrate are dyed a first color, and said coating carries a colorant of a second color.

8. The fabric of claim 7 having areas on said substrate face that display said first color and areas on said substrate face that display said second color, and, additionally, having areas on said face in which said first color and said second color contribute to display combinations of said first and said second colors.

9. The fabric of claim 1 wherein said coating remains substantially on the contoured surface with little penetration into the underlying structure of the substrate.

10. The fabric of claim 8 wherein said coating is substantially opaque.

11. The fabric of claim 8 wherein said coating is in contact with a chemical finish associated with said face.

12. A process for manufacturing a composite fabric, said process comprising the steps of
a. providing a textile substrate having a face and a back, said face being locally contoured and having, within a localized area, relatively elevated areas and relatively depressed areas, and
b. providing to said face a coating that is non-uniform in thickness and that, when cured, generally is thicker in said relatively depressed areas than elsewhere on said face

13. The process of claim 12 wherein Step a is achieved by fabricating said substrate using a fabric formation technique selected from the group consisting of circular knitting, tricot knitting, raschel knitting, jacquard weaving, and dobby weaving, and wherein said locally contoured face is at least partially the result of selection of an appropriate pattern used with said fabric formation technique.

14. The process of claim 13 wherein Step a is achieved by fabricating said substrate using non-woven fabric formation techniques, and wherein said locally contoured face is at least partially the result of selection of an appropriate pattern used with said fabric formation techniques.

15. The process of claim 12 wherein said substrate provided in Step a is comprised of textile yarns that were dyed in a previous step.

16. The process of claim 12 wherein the process of Step a includes the selective treatment of said substrate by a patterning technique selected from the group consisting of heated fluid streams, high velocity fluid streams, embossing, embroidering, laser etching, chemical etching, and ultrasonic etching, thereby at least partially providing said local contouring of said substrate face.

17. The process of claim 12 wherein Step b is achieved by applying a coating material having a viscosity within the range of about 80,000 centipoise and about 400,000 centipoise

18. The process of claim 17 wherein said coating material has a viscosity within the range of about 200,000 centipoise and about 300,000 centipoise.

19 The process of claim 18 wherein said coating material is applied using a knife coater.

20. The process of claim 18 wherein said coating material is relatively opaque.

21. The process of claim 18 wherein said coating material contains a colorant.

22. The process of claim 12 wherein Step b includes applying said coating and abrading said coating in said relatively elevated areas.

23. The process of claim 12 that further comprises the application of a backing layer to said substrate.

24. The process of claim 23 wherein said backing layer is in the form of a back coat.
